(19) United States
(12) Patent Application Publication
(10) Pub. No.: US 2026/0115966 A1
(43) Pub. Date: Apr. 30, 2026

(54) INDUSTRIAL MIXING AND STORAGE CONTAINER

(71) Applicant: LAKE ASPHALT OF TRINIDAD AND TOBAGO (1978) LIMITED, La Brea (TT)

(72) Inventor: Barry Antonio REGIS, Oropouche (TT)

(21) Appl. No.: 19/368,834

(22) Filed: Oct. 24, 2025

Related U.S. Application Data
(60) Provisional application No. 63/711,967, filed on Oct. 25, 2024.

(51) Int. Cl. B28C 5/02; B60P 3/22; B65D 88/74; E01C 19/08

(52) U.S. Cl. CPC B28C 5/026; B65D 88/748; E01C 19/08; B60P 3/2205; B60P 3/2295

(57) ABSTRACT

A heatable storage tank includes a storage chamber arranged to hold a material. The storage tank may include a heating element disposed in the storage chamber to heat the material. The storage tank may also include a jet mixing device to mix the material in the storage chamber. The jet mixing device may include an array of nozzles configured to eject the material from the nozzles and into the storage chamber to agitate and mix the material in the storage chamber. The nozzles may be positioned in a lower half of the storage chamber and oriented to eject the material downwardly toward the bottom wall.

### CROSS REFERENCE TO RELATED APPLICATIONS

This application claims the benefit of U.S. Provisional Application No. 63/711,967, filed Oct. 25, 2024, which is incorporated herein by reference in its entirety.

### TECHNICAL FIELD

The present technology relates generally to mixing and storage containers for industrial purposes, and more particularly to mobile containers for mixing, heating and/or storing viscous materials such as asphalt cement.

### BACKGROUND

Large storage containers or tanks are used for various industrial purposes. For example, some tanks mix, heat and store liquids, including viscous materials such as pitch (e.g., asphalt cement (i.e., natural and/or manufactured bitumen)). Asphalt cement (or asphalt binder) is a highly viscous liquid or semi-solid used to bind aggregates (e.g., gravel, rock and/or sand) in the production of asphalt pavements (i.e., asphalt concrete). Typically, the asphalt binder binds the aggregates at high temperatures (e.g., 200° F. to above 300° F.) to create a solid and durable pavement. The asphalt binder is heated separately from the aggregates and then later combined with the aggregates before being laid to form the asphalt pavement.

Thus, there is a need for storage tanks that can store the asphalt binder at high temperatures so that it is readily available for mixing with the aggregates. Additionally, because silt or fine particles in the binder tend to settle at the bottom of such tanks, there is a need for storage tanks that can keep the asphalt binder properly blended while maintaining the material at appropriate temperatures. Since it is often advantageous to transport the binder material to or near various worksites, what is also needed is a storage tank that is mobile.

### SUMMARY

One aspect of the disclosed technology relates to a storage tank that mixes a material (e.g., a viscous material) without the use of mechanical stirrers.

Another aspect of the disclosed technology relates to a storage tank with self-cleaning capabilities preventing silt from settling at the bottom of the tank.

Another aspect of the disclosed technology relates to a mobile storage tank capable of heating a material to temperatures above 200° F. while keeping the material thoroughly mixed.

Another aspect of the disclosed technology relates to a heatable storage tank. The heatable storage tank comprises: 1) a bottom wall; 2) at least one side wall, the bottom wall and the at least one side wall form a storage chamber configured to hold a material; 3) at least one heating element disposed in the storage chamber and configured to heat the material; and 4) a jet mixing device configured to agitate and mix the material in the storage chamber, wherein the jet mixing device includes an array of nozzles configured to eject the material from the nozzles and into the storage chamber to agitate and mix the material in the storage chamber, and wherein the nozzles are positioned in a lower half of the storage chamber, and the nozzles are oriented to eject the material downwardly toward the bottom wall.

Another aspect of the disclosed technology relates to a system for mixing and storing a material. The system comprises: 1) a tank having an interior portion forming a storage chamber configured to hold a material, the tank including a bottom wall; 2) a recirculation pump disposed outside of the storage chamber and configured to suction the material from the storage chamber and then return the material to the storage chamber; 3) a supply manifold disposed in the storage chamber and fluidly connected to the recirculation pump; and 4) a plurality of nozzles disposed in the storage chamber and configured to receive the material from the supply manifold, wherein the nozzles are configured to eject the material from the nozzles into the storage chamber to agitate and mix the material in the storage chamber, and wherein the nozzles are disposed within a range of 3 inches to 10 inches from the bottom wall.

Other aspects, features, and advantages of this technology will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this technology. In such drawings:

FIG. 1 is a side perspective view of a storage tank according to an example of the disclosed technology;

FIG. 2 is a schematic representation of an interior of the storage tank of FIG. 1 according to an example of the disclosed technology;

FIG. 3 shows one of the thermal exchange devices depicted in FIG. 1 according to an example of the disclosed technology;

FIG. 4 shows the steam agitation device depicted in FIG. 1 according to an example of the disclosed technology;

FIG. 5 is an enlarged detail of one of the agitation tubes of the agitation device in FIG. 4 according to an example of the disclosed technology;

FIG. 6 shows the jet mixing device depicted in FIG. 1 according to an example of the disclosed technology;

FIG. 7 shows a supply conduit and nozzles of the jet mixing device in FIG. 6 according to an example of the disclosed technology;

FIG. 8 shows a jet mixing device according to another example of the disclosed technology;

FIG. 9 shows a supply conduit and nozzle arrangement according to an example of the disclosed technology;

FIG. 10 shows a supply conduit and nozzle arrangement according to another example of the disclosed technology; and

FIG. 11 is a partial perspective view of a portion of an interior of a storage tank according to an example of the disclosed technology.

### DETAILED DESCRIPTION OF ILLUSTRATED EXAMPLES

The following description is provided in relation to several examples (most of which are illustrated) which may share some common characteristics and features. It is to be understood that one or more features of any one example may be combinable with one or more features of the other examples. In addition, any single feature or combination of features in any of the examples may constitute additional examples.

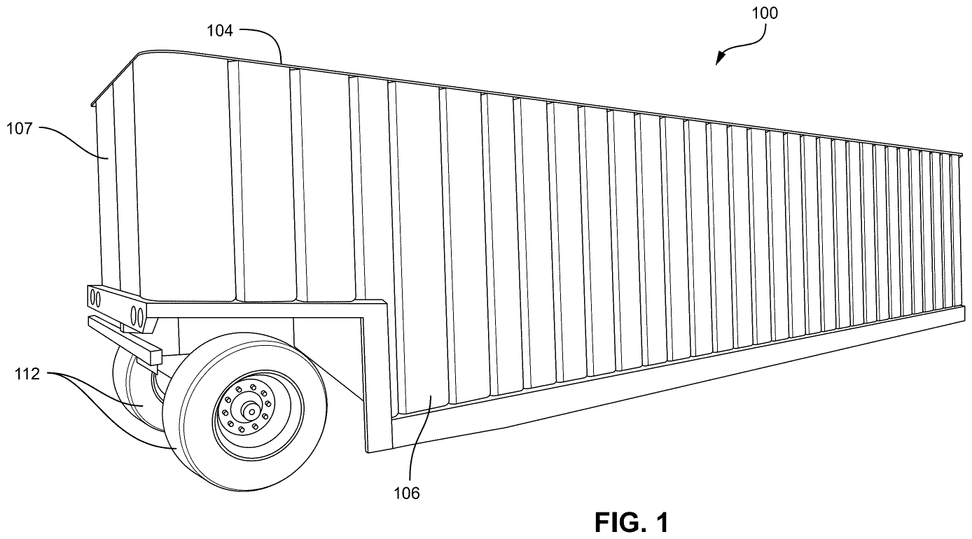

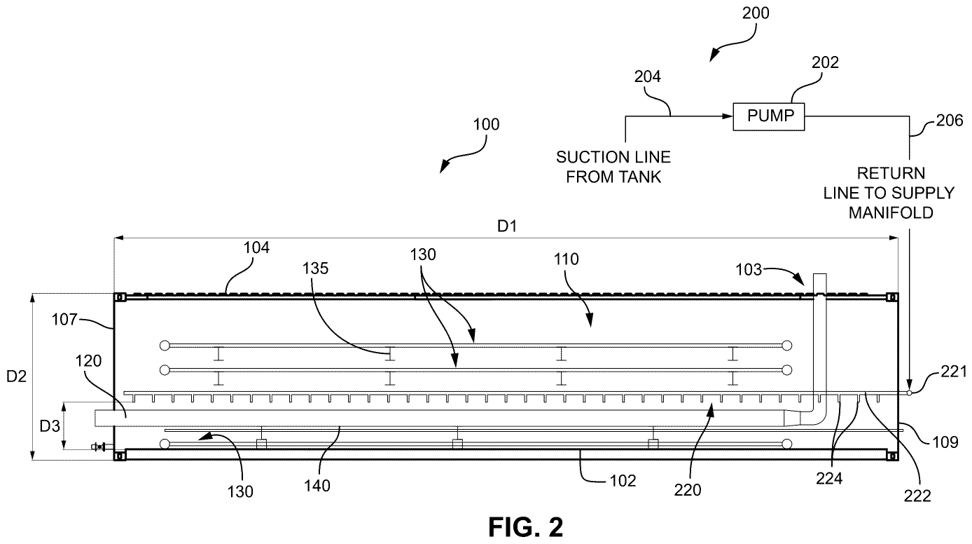

Referring to FIG. 1, a mobile container, or storage tank 100, is shown. As can be seen in FIGS. 1 and 2, the storage tank may have a bottom wall 102, top wall 104 and at least one side wall (e.g., lateral walls 106, rear wall 107 and front wall 109). In the illustrated example, the storage tank 100 has a rectangular shape similar to the shape of a shipping container or semi-trailer with wheels 112 at one end. The elongate rectangular shape facilitates mobility of the storage tank as the front end of the tank may be attached to a truck and the tank may be transported similarly to a semi-trailer.

In other examples, instead of a rectangular shape, the storage tank 100 may have other configurations. For example, the storage tank could have a square shape, or a cylindrical shape where the at least one side wall is one continuous side wall.

Turning to FIG. 2, a schematic representation of an interior of the storage tank 100 is shown. The storage tank may have any suitable length D1 (e.g., 15-60 ft, 20-40 ft, more than 20 ft, 20 ft, or 40 ft). The storage tank may have any suitable height D2 (e.g., 5-18 ft, 5-10 ft, more than 5 ft, 10 ft, or 15 ft). The interior of the tank includes a storage chamber 110 arranged to receive and hold a material. The material, for example, may be a liquid or semi-solid material. The storage tank 100 may be particularly suitable for viscous materials due to its heating capabilities. The storage tank may be capable of heating the material to high temperatures which may melt or liquefy the material making it more flowable and easier to work with. For example, the storage tank 100 may be used to heat, mix and store asphalt binder in preparation for mixing with aggregates in the process of laying asphalt pavement.

Still referring to FIG. 2, the storage tank 100 includes a material recirculation system 200 that mixes the material in the tank for the purpose of homogeneity and also provides the tank with self-cleaning capabilities by agitating and thereby preventing silt from settling at the bottom of the storage tank. The system is advantageous as it avoids mechanical stirrers which require numerous moving parts and multiple openings into the side walls of the container which must be properly sealed and maintained to avoid leaks. The material recirculation system 200 includes a recirculation pump 202, suction line 204, return line 206, and jet mixing device 220. The recirculation pump 202 continuously circulates material from the storage chamber to an area outside of the tank and then back to the storage chamber. The jet mixing device 220 is configured to inject the material into the storage chamber in a manner that encourages homogeneity and self-cleaning. The suction line 204 conveys material from the storage chamber 110 to the recirculation pump, and the return line 206 conveys the material from the recirculation pump to the jet mixing device 220. In another example, the material recirculation system 200 may recirculate the material without removing the material from the storage chamber (e.g., by use of a submersible pump).

The jet mixing device 220 includes a supply manifold 221, at least one supply conduit 222, and a plurality of nozzles 224 forming a nozzle array. The supply manifold 221 is fluidly connected to the return line 206 to receive material suctioned from the storage chamber. At least one (e.g., 2 or more, 3 or more, 5 or more, 2, 3, 4, 5, or 6) supply conduit 222 is configured to receive material from the supply manifold. Each supply conduit 222 extends across the storage chamber 110 and has a plurality of nozzles 224 extending downwardly from the supply conduit and aimed towards the bottom wall 102. The nozzles 224 may be positioned in a lower half of the storage chamber. In some examples, a distance D3 between the nozzles and the bottom wall 102 may be within a range of 1 to 15 inches (e.g., 3 to 12 inches, 3 to 10 inches, 5 to 8 inches, 4 inches, 6 inches, 8 inches, or 12 inches) to facilitate agitation of silt that may settle along the bottom wall. The suction line 204 is connected to the storage chamber 110 at any height that is greater than D3 so that the material suctioned from the storage chamber is well mixed. In an example, the suction line may be positioned at any height above 20 inches.

The storage tank 100 may also include at least one heating element. In the illustrated example, the storage tank includes at least one (e.g., 2 to 6, 2, 3 or 4) hot tube 120 and at least one (e.g., 2 or 3) thermal exchange device 130, although in some examples only one type of heating element may be used. The hot tubes 120 may extend through the storage chamber along a lower portion of the chamber and then may vent through an opening 103 in the top wall 104. The hot tubes 120 may be metal tubes having direct fire burners attached at the ends of the tubes to heat the tubes thereby transferring heat to the material.

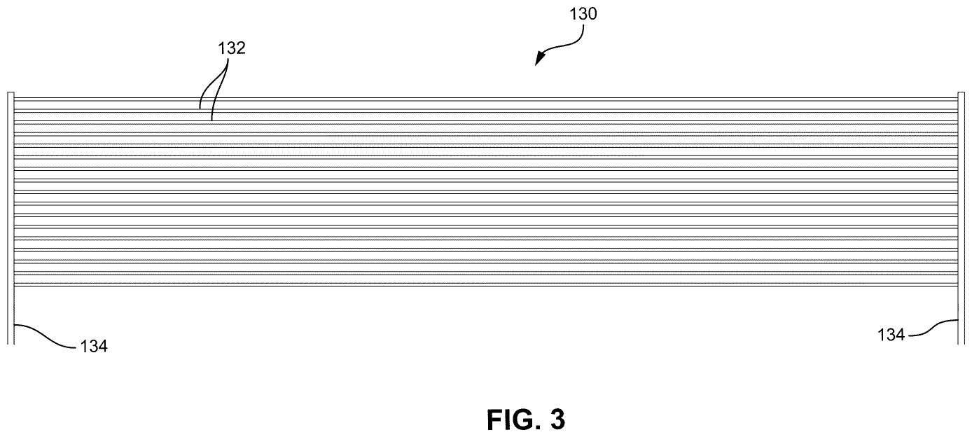

The thermal exchange device 130 may, for example, pass steam or oil through its pipes 132 to heat the material. The thermal exchange device 130 may, for example, be in the form of a coil (e.g., serpentine shape) or individual pipes connected at their ends by manifolds. In the illustrated example of FIG. 2, the thermal exchange device 130 has a three-tier arrangement with three devices disposed respectively at three different heights in the storage chamber. In the example of FIG. 3, the thermal exchange device 130 includes a plurality of individual pipes 132 (e.g., 12 to 20) connected to a pair of thermal manifolds 134.

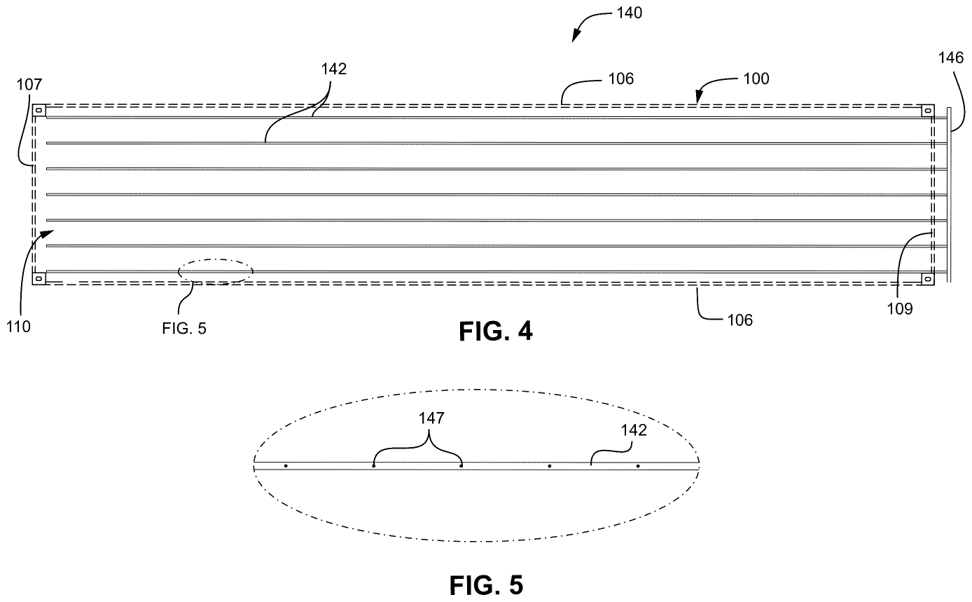

In some examples, the storage tank 100 may also include a steam agitation device 140 placed near the bottom wall 102 as a backup, secondary or complementary agitation and self-cleaning device to the material recirculation system 200. As shown in FIGS. 4 and 5, the steam agitation device 140 may include an agitation manifold 146 that supplies a plurality of agitation tubes 142 (e.g., 5 to 10) with dry steam. In another example, the agitation manifold 146 may be disposed inside the storage chamber 110. In this way, a single hole can be formed in the side wall of the tank to feed the manifold instead of forming a hole in the tank for each agitation tube 142. Each agitation tube 142 includes a plurality of spaced holes 147 configured to force inject the dry steam into the material to agitate the material for the purpose of homogenization.

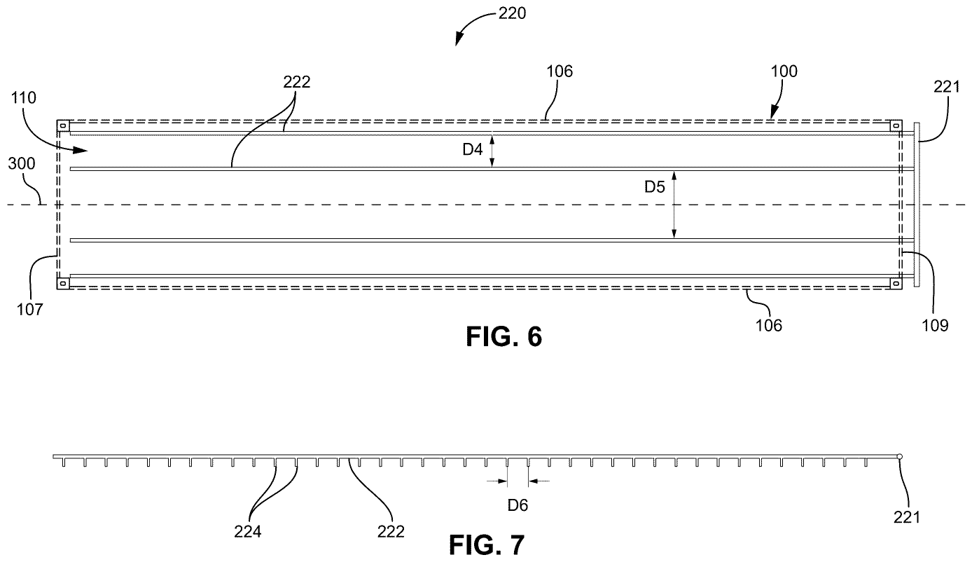

Turning to FIGS. 6-8, examples of the jet mixing device 220 are shown. In the example of FIG. 6, the jet mixing device has four supply conduits 222 with a pair of outer supply conduits and a pair of inner supply conduits. The supply conduits 222 may be spaced so that no supply conduit extends along a central longitudinal axis 300 of the storage chamber. However, in other examples, a supply conduit may extend along the central longitudinal axis 300.

The distance D4 between the inner and outer supply conduits may be the same as or different than the distance D5 between the inner supply conduits. In some examples, all of the supply conduits are equally spaced, whereas in other examples the spacing between the supply conduits 222 may vary.

Valves may be used to selectively allow flow to certain supply conduits 222. For example, a first valve may be used to control the flow to the outer supply conduits, and a second valve may be used to control the flow to the inner supply conduits.

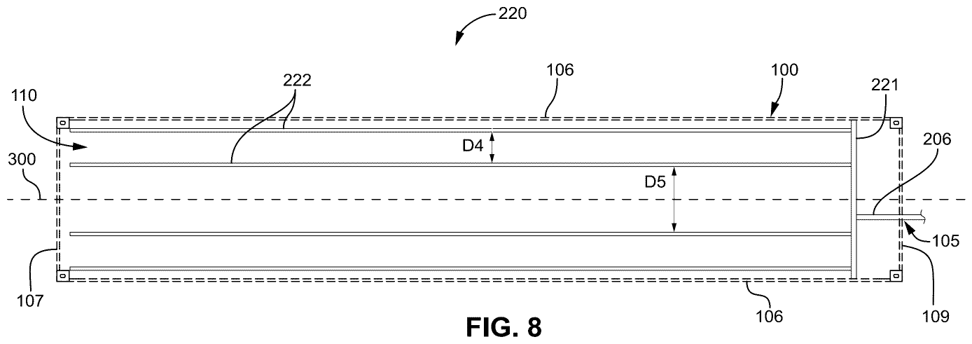

In the example of FIG. 6, the supply manifold 221 is disposed outside of the storage chamber 110. However, in the example of FIG. 8, the return line 206 may extend through the side wall of the storage tank 100 such that the supply manifold 221 is disposed inside the storage chamber 110. In this way, only one opening 105 into the side wall is formed instead of multiple openings for each supply conduit. Where two valves are used to control the inner and outer supply conduits, two return lines may extend into the storage chamber.

In other examples, instead of the supply conduits 222 extending longitudinally along the storage chamber 110, the supply conduits could extend transversely in the storage chamber. In such examples, the supply manifold 221 may extend longitudinally along an interior of the storage chamber.

As shown in FIG. 7, the nozzles 224 may extend from the supply conduits is a spaced apart arrangement. In some examples, the nozzles may be spaced apart by a distance D6 (e.g., 6 to 18 inches, 9 to 15 inches, 6 inches, 9 inches, 12 inches or 15 inches).

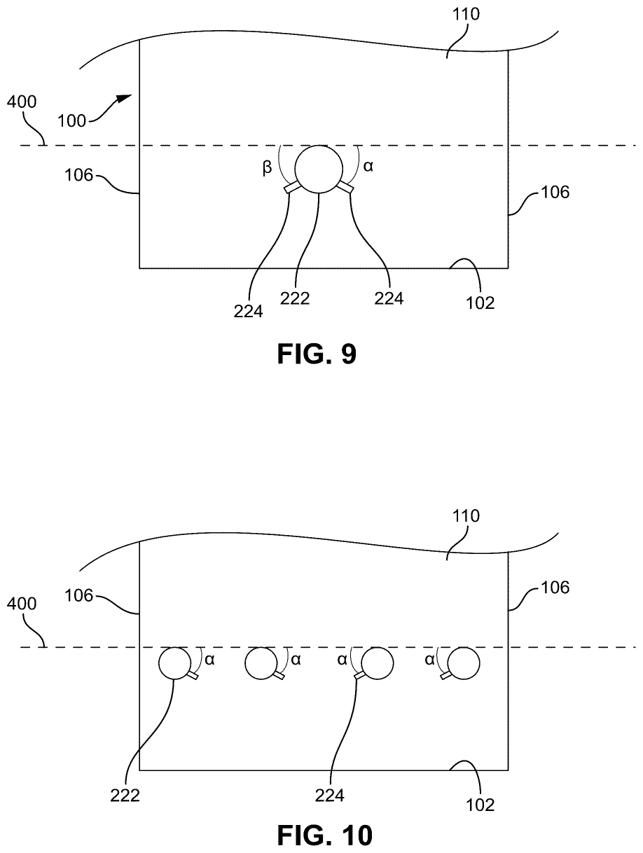

Turing to FIGS. 9 and 10, examples are shown which depict various arrangements and orientations of the supply conduits 222 and nozzles 224. In FIG. 9, the storage tank 100 has a single supply conduit 222 extending along the central longitudinal axis with nozzles extending in different directions. A first set of nozzles 224 may extend downwardly towards the bottom wall 102 on a first side of the supply conduit 222, and a second set of nozzles 224 may extend downwardly towards the bottom wall on a second side of the supply conduit. The first set of nozzles may alternate with the second set of nozzles such that along the length of the supply conduit 222 a first nozzle adjacent an end of the supply conduit extends in the first direction, the second nozzle along the length of the supply conduit extends in the second direction, the third nozzle along the length of the supply conduit extends in the first direction, and so on.

The first set of nozzles may extend at an angle α with respect to a horizontal axis 400, and the second set of nozzles may extend at an angle β with respect to the horizontal axis. The angles α and β may be in the range of 30-90° (e.g., 30-75°, 45°, or) 75°. In some examples, the angles α and β may be the same, whereas in other examples, α and β may be different. Angling the nozzles with respect to the bottom wall 102 creates a flow of the material that advantageously stirs fine particles attempting to settle at the bottom of the storage tank.

In the FIG. 10 example, the storage tank 100 has four supply conduits 222 extending along the storage chamber 110. All of the nozzles are angled downwardly and inwardly towards the central longitudinal axis 300. In this way, the nozzles force material towards the longitudinal center of the storage chamber thereby creating a mixing motion that facilitates homogeneity and self-cleaning. In some examples, the angle α of the nozzles on the pair of outer supply conduits may be different than the angle α of the nozzles on the pair of inner supply conduits. In other examples, the nozzles may be angled downwardly and outwardly towards the side walls. The angles α and β may vary for different sized storage tanks and may be adjusted accordingly in order to create a flow the best promotes homogeneity and self-cleaning.

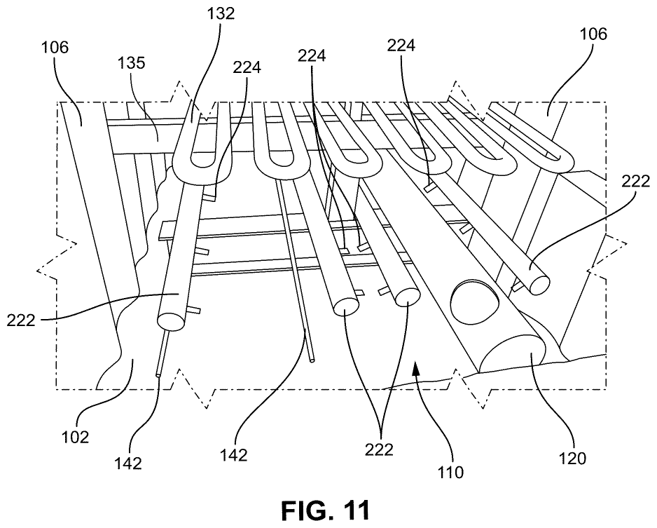

FIG. 11 shows an example of a portion of the storage chamber 110. In this example, the storage tank has four supply conduits 222. The inner conduits are spaced closer together than the inner conduits are to their respective outer conduit.

In some examples, the storage tank 100 may have a modular arrangement. For example, multiple storage tanks may be fluidly connected to increase the overall storage capacity onsite. In an example, three storage tanks 100 may be positioned side-by-side so that they are closely arranged. Each tank may have a port that can be used to fluidly connect (e.g., with suitable conduits/piping) the tank to the tank(s) next to it. In this example, the center tank may be connected to both of the outer tanks. It may be possible to circulate material through the tanks utilizing only one pump instead of three. Further, this arrangement may be advantageous when a large amount of the material is needed. It may be possible to provide the large supply at one time without having to fluidly connect to three separate tanks. Each tank may also be provided with its own pump so that, if desired, the three tanks could be fluidly disconnected to operate as stand-alone tanks.

While the examples discussed above have been described in connection with what are presently considered to be practical and preferred features, it is to be understood that appended claims are intended to cover modifications and equivalent arrangements included within the spirit and scope of these examples.

What is claimed is:

1. A heatable storage tank, comprising:
bottom wall;
at least one side wall;
the bottom wall and the at least one side wall forming a storage chamber configured to hold a material;
at least one heating element disposed in the storage chamber and configured to heat the material; and
a jet mixing device configured to agitate and mix the material in the storage chamber, the jet mixing device including:
an array of nozzles configured to eject the material from the nozzles and into the storage chamber to agitate and mix the material in the storage chamber,
wherein the nozzles are positioned in a lower half of the storage chamber, and the nozzles are oriented to eject the material downwardly toward the bottom wall.

2. The heatable storage tank of claim 1, wherein each nozzle of the array of nozzles is angled inwardly towards a central longitudinal axis of the storage chamber.

3. The heatable storage tank of claim 1, wherein the nozzles are disposed within a range of 3 inches to 10 inches from the bottom wall.

4. The heatable storage tank of claim 1, wherein proximity of the nozzles to the bottom wall facilitates raising of settled silt in the material.

5. The heatable storage tank of claim 1, wherein the array of nozzles includes at least one row of nozzles extending lengthwise in the storage chamber.

6. The heatable storage tank of claim 5, wherein the jet mixing device includes at least one supply conduit, the nozzles being connected to and extending downwardly from the at least one supply conduit such that each row of nozzles extends along a respective supply conduit.

7. The heatable storage tank of claim 6, wherein the at least one supply conduit includes a first supply conduit, a first group of the nozzles connected to the first supply conduit being oriented to eject the material downwardly in a first direction, and a second group of the nozzles connected to the first supply conduit being oriented to eject the material downwardly in a second direction that is different than the first direction.

8. The heatable storage tank of claim 6, wherein the at least one supply conduit includes a plurality of supply conduits, and the at least one row of nozzles includes a plurality of rows of nozzles corresponding respectively to the plurality of supply conduits.

9. The heatable storage tank of claim 8, wherein the jet mixing device includes a supply manifold, the plurality of supply conduits being configured to receive the material from the supply manifold.

10. The heatable storage tank of claim 9, wherein the supply manifold is disposed within the storage chamber.

11. The heatable storage tank of claim 10, wherein the supply manifold is configured to receive a supply of the material that is recirculated from the storage chamber.

12. The heatable storage tank of claim 8, wherein the plurality of supply conduits includes a pair of outer supply conduits disposed relatively proximal the at least one side wall and a pair of inner supply conduits disposed relatively proximal a central longitudinal axis of the storage chamber.

13. The heatable storage tank of claim 12, wherein the nozzles connected to the outer supply conduits are angled downwardly and inwardly to eject the material downwardly and towards the central longitudinal axis of the storage chamber.

14. The heatable storage tank of claim 13, wherein the nozzles connected to the inner supply conduits are angled downwardly and inwardly to eject the material downwardly and towards the central longitudinal axis of the storage chamber.

15. The heatable storage tank of claim 1, further comprising at least one heating element configured to heat the material in the storage chamber.

16. The heatable storage tank of claim 15, wherein the at least one heating element is configured to heat the material to temperatures above 200° F.

17. A system for mixing and storing a material, comprising:
a tank having an interior portion forming a storage chamber configured to hold a material, the tank including a bottom wall;
a recirculation pump disposed outside of the storage chamber and configured to suction the material from the storage chamber and then return the material to the storage chamber;
a supply manifold disposed in the storage chamber and fluidly connected to the recirculation pump; and
a plurality of nozzles disposed in the storage chamber and configured to receive the material from the supply manifold,
wherein the nozzles are configured to eject the material from the nozzles into the storage chamber to agitate and mix the material in the storage chamber, and
wherein the nozzles are disposed within a range of 3 inches to 10 inches from the bottom wall.

18. The system of claim 17, further comprising a recirculation line connected to the recirculation pump and configured to provide the material to the supply manifold.

19. The system of claim 17, wherein the array of nozzles is angled inwardly towards a central longitudinal axis of the storage chamber.

20. The system of claim 17, further comprising at least one heating element configured to heat the material in the storage chamber to temperatures above 200° F.
